(19) United States
(12) Patent Application Publication
(10) Pub. No.: US 2023/0381053 A1
(43) Pub. Date: Nov. 30, 2023

(54) POWERED WALKER DEVICE, SYSTEM AND METHOD

(71) Applicants: Barron Associates, Inc., Charlottesville, VA (US); University of Virginia Patent Foundation, Charlottesville, VA (US)

(72) Inventors: Jason O. Burkholder, Charlottesville, VA (US); John D. Schierman, Kettering, OH (US); David A. Neal, III, Charlottesville, VA (US); William T. Gressick, Charlottesville, VA (US); Aaron B. Olowin, Charlottesville, VA (US); B. Eugene Parker, JR., Charlottesville, VA (US); Christopher J. Wiles, Charlottesville, VA (US); Jared K. Cooper, Charlottesville, VA (US); Merrick L. Furman, Charlottesville, VA (US); Shawn Russell, Earlysville, VA (US)

(21) Appl. No.: 17/824,078

(22) Filed: May 25, 2022

(51) Int. Cl. A61H 3/04

(52) U.S. Cl. CPC A61H 3/04; A61H 2003/043; A61H 2003/046; A61H 2201/5092; A61H 2201/5064; A61H 2201/5061; A61H 2201/1215

(57) ABSTRACT

Embodiments of the present disclosure include a walker equipped with one or more sensors, an onboard controller, powered wheels and associated motor controllers. The walker can sense its distance from the user and activate the powered wheels when commanded by the controller. The controller can execute programming including an automatic feedback control algorithm that regulates the distance between the walker frame and the user. In this manner, the walker automatically follows the user, keeping the user from having to expend energy to pull the walker along. The walker can then be utilized by the user solely for balance and support.

### STATEMENT

This invention was made with U.S. Government support under grant no. 2RR44HD082863-02 awarded by the National Institutes of Health. The Government has certain rights in the invention.

### TECHNICAL FIELD

The present disclosure pertains to medical devices and, more specifically, to a powered walker with a sensor arrangement for effectively supporting a user's mobility.

### BACKGROUND AND SUMMARY

Traditional walkers assist those who may have difficulty walking by providing support and stability when needed. In some cases, walkers are movable solely by human power while in other cases, walkers are capable of self-propulsion.

Embodiments of the present disclosure provide a walker for various user types, including children and young adults with cerebral palsy and similar walking disabilities, geriatric populations and users recovering from stroke or injury. The walker can be employed as a posterior walker or an anterior walker. Embodiments as disclosed herein make walking easier for individuals with neuromuscular disabilities using a computer-aided, power-assisted walker that helps reduce metabolic costs through intelligent, adaptive control. By easing the burden of walking, these individuals will be encouraged to walk more often, which will ideally delay or even obviate any later transition to wheelchair use. This will help to improve quality of life and yield important cardiovascular, musculoskeletal, mental, and social benefits.

According to various embodiments, a walker as disclosed herein is equipped with a sensor, an onboard controller, and powered wheels with associated motors. The walker can sense its distance from the user and activate the powered wheels when commanded by the controller. An automatic feedback control algorithm can be housed within the controller and can regulate the distance between the walker frame and the user. In this manner, the walker can automatically follow the user, keeping the user from having to expend energy to pull the walker along. The walker can then be utilized by the user solely for balance and support.

In various aspects, one or more control algorithms are employed to automatically operate the walker while learning and adapting to each individual user's gait characteristics to deliver unique locomotive profiles that result in consistent reduction in the metabolic costs of walking.

An adaptive control scheme can be employed according to various embodiments, such as a Model Reference Adaptive Control (MRAC), adaptive machine learning techniques such as genetic and evolutionary algorithms, reinforcement learning and other approaches. The control algorithms adapt the torque motor input profiles depending on the user's current ambulation characteristics, which can change due to fatigue, walking path grade/features and other reasons. In this approach, the system model consists of both the powered walker and the human user, and the controller adapts to variations in the human biomechanical dynamics.

In various embodiments, an infrared (IR) optical sensor is employed to determine the distance between the user and the walker frame. Other sensors, including one or more depth cameras, electro-optical cameras and ultrasonic or other proximity sensors can provide multi-detection redundancy, improving on sensing accuracy and robustness. Additionally, single or multi-axis force sensors housed in the walker handles can provide additional input modalities to the control algorithms, improving turning performance, for example.

### BRIEF DESCRIPTION OF THE DRAWINGS

FIG. 1 is a perspective view of a walker device in accordance with embodiments of the present disclosure.

FIG. 2 is a side view of the walker device of FIG. 1 shown with a user employing the walker device as a posterior walker.

FIG. 3 is an exemplary method in accordance with embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

It will be appreciated that reference to “a”, “an” or other indefinite article in the present disclosure encompasses one or more than one of the described element. Thus, for example, reference to a processor may encompass one or more processors, a wheel may encompass one or more wheels, a camera may encompass one or more cameras and so forth.

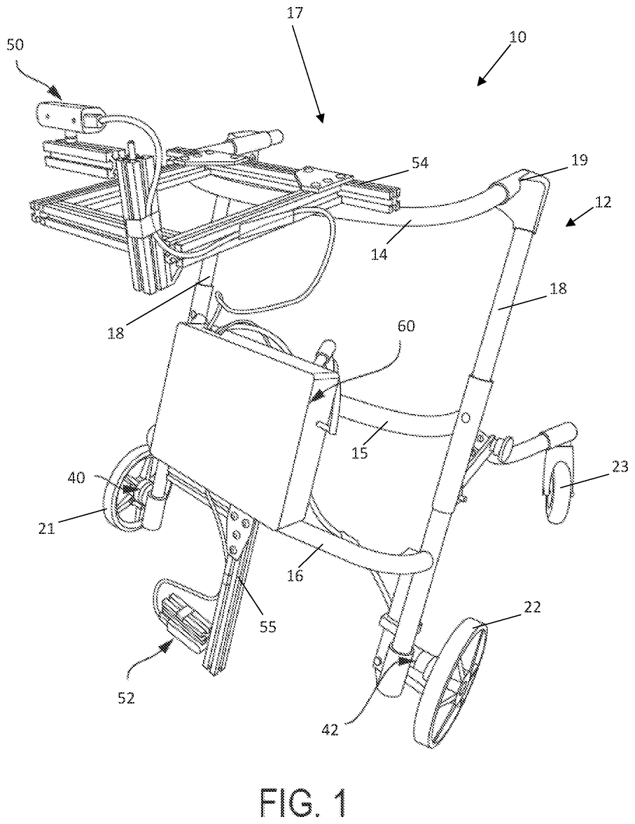

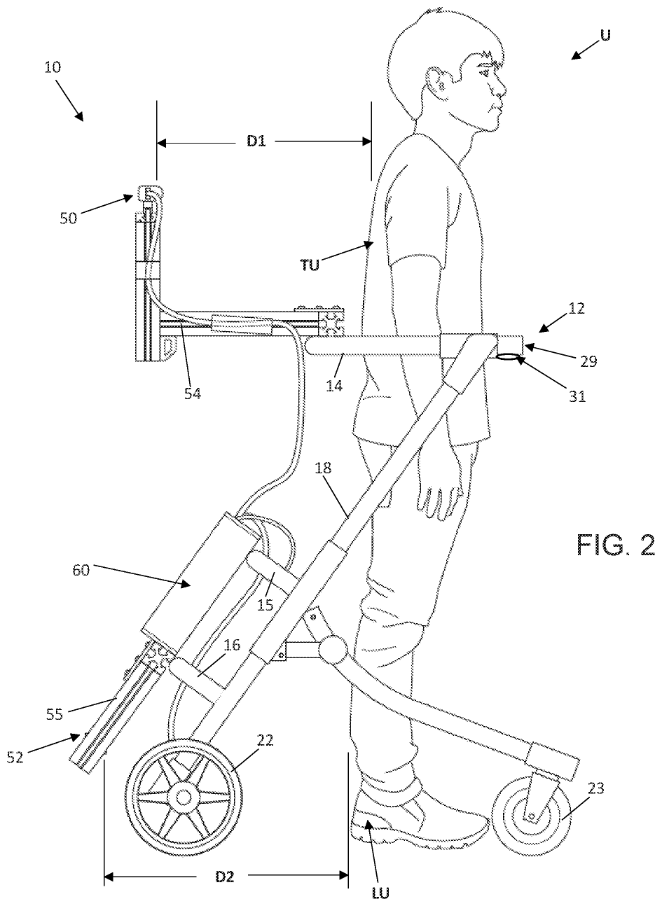

As shown in FIGS. 1 and 2, a powered walker 10 is provided with a frame 12. The frame 12 has an upper segment 14, a lower segment 16 and side frame supports 18 that are secured together mechanically such as by sleeves 19, nuts and bolts or in similar fashion. In various embodiments, a mid-segment 15 is provided between the frame supports 18. The upper segment 14, lower segment 16 and mid-segment 15 assist in maintaining the side frame supports 18 evenly spaced apart to facilitate operation of the walker 10. The frame 12 defines a user gap 17 where a user may position himself or herself during operation.

A powered set of wheels 21, 22 and a freewheeling set of wheels (one wheel 23 of the freewheeling set shown in FIG. 1) are rotatably secured to the frame 12. In various embodiments, the freewheeling wheels (e.g., 23) are caster wheels which can lock, depending on user preference. A first wheel motor 40 is secured to the frame and operable to direct motion and braking of the first wheel 21. A second wheel motor 42 is secured to the frame and operable to direct motion and braking of the second wheel 22. In various embodiments, the motors 40, 42 are servo motor drives housed at the base of each powered wheel 21, 22. The servo drives are designed for direct current/torque control of motors for precision control applications at high bandwidth. In various embodiments, each motor 40, 42 connects to a right-angle planetary gearhead. There is a motor/gearbox combination 40 that directly drives wheel 21 and a motor/gearbox combination 42 that directly drives wheel 22. These combinations may be referred to as motor 40 and/or motor 42 herein for ease of reference. In various embodiments, the servo motor drives are controllable by a controller 60 as described elsewhere herein to assist in processing instructions for propulsion and braking of the respective wheels 21, 22.

In various embodiments, a first sensor 50 such as a depth camera is secured to the upper segment 14 and a second sensor 52 such as an additional depth camera is secured to the lower segment 16. When embodied as depth cameras, these sensors provide a point cloud of depth data in their field of view. The first sensor 50 can be secured to a top bracket 54 that is directly secured to the upper segment 14, and the second sensor 52 can be secured to a lower bracket 55 that is directly secured to the lower segment 16, as shown in FIG. 1. According to embodiments such as shown in FIG. 2, the top bracket 54 can be adapted or positioned so as to permit the first sensor 50 to measure a first distance D1 from a torso TU of a user U during operation, and the lower bracket 55 can be adapted or positioned to permit the second sensor 52 to measure a second distance D2 from a foot or lower leg LU of the user U during operation. In various embodiments, D1 is less than D2 when the user U is stationary as shown in FIG. 2. Further, it will be appreciated that D1 and D2 are at least a minimum distance of eight inches from the user U to facilitate accurate depth measurements and properly informing algorithms associated with the present disclosure.

As shown in FIGS. 1 and 2, the central controller 60 can be secured to the frame 12 and communicatively coupled to the sensors 50, 52 and the motors 40, 42 in order to receive and process inputs from the sensors 50, 52 and direct appropriate movement and/or braking of one or both wheels 21, 22 via one or more signals sent to one or both of the respective motors 40, 42. The controller 60 can incorporate necessary processing power and memory for storing data and programming that can be employed by the processor(s) to carry out the functions and communications necessary to facilitate the processes and functionalities described herein. The instructions can include one or more algorithms that receive and process inputs from the sensors 50, 52. In various embodiments, the controller 60 is secured to the mid-segment 15 of the frame 12. In some embodiments, the controller 60 is in wireless communication with a remote computing device to permit the remote computing device to control the walker 10.

It will be appreciated that the controller 60 can direct one or both motors 40, 42 based on a single input from either the first sensor 50 or the second sensor 52, or based upon multiple inputs from one or both sensors 50, 52. In embodiments, the controller 60 issues a signal to one or both motors 40, 42 to regulate the distance between the frame 12 and a user U positioned in the user gap 17. One or more inputs can be a detected distance from the first sensor 50 to a torso TU of a user U and one or more inputs can be a detected distance from the second sensor 52 to a foot or lower leg LU of a user U. In various embodiments, an input to the controller can be a detected time period from a heel ground strike of a user to a toe lift-off of the user, such as measured by sensor 52. Further, an output or signal to the wheels/motors can direct at least one wheel to add propulsive force at the toe lift-off of the user and to add braking force at the heel ground strike of the user. In embodiments, outputs or signals can be sent independently to the first wheel/motor and the second wheel/motor. For example, a first signal may direct the braking of the first wheel and a second signal may direct forward or backward propulsion o the second wheel. Such signals can be sent at the same time or at different times. Further, in various embodiments, the sensor 52 can track a gait cycle of a user. In such ways, the device, system and method as disclosed herein can help ensure proper positioning of the walker 10 and ease the burden of walking for the user.

It will be appreciated that the use of two depth cameras to automatically characterize user's gait and independently actuate the respective motors provides optimized input and minimize the user's energy expenditure. Specifically, the first sensor 50 can provide consistent relative location of the walker 10 to the user U. The first sensor 50 can also be used to ascertain desired direction of locomotion based on torso orientation and quickly identify stumbles/loss of balance to help restore stability. The second sensor 52 can be used to track the gait cycle and add propulsive force at the optimal phase in the cycle (e.g., toe off) and contribute braking force at the appropriate phase in the cycle (e.g., heel strike) in order to minimize user energy expenditure when walking. In various embodiments, the system can identify and track the user's desired stride length and frequency in order to tailor the user's behavior for maximum benefit.

While the first and second sensors 50, 52 are exemplified as depth cameras above, it will be appreciated that the sensors described herein can be different types of sensors, including laser sensors and infrared sensors, for example. It will further be appreciated that embodiments of the present disclosure can include an ultrasonic sensor secured to the frame for proximity detection. It will be appreciated that aspects of the present disclosure provide an integrated system that includes both the powered walker and the human user as a system to be controlled. The wide variations both for different users and for the same user over time can be viewed as large changes to the system dynamics. Different walking conditions, such as up or down grades, in poor weather, etc., can be viewed as external disturbances to the system. With adaptive feedback control, the controller as disclosed herein can autonomously adjust design parameters in real-time to address such system variations and external disturbances. In this way, locomotive strategies can be delivered that provide consistent, robust ambulatory aid to the user in the face of continuously changing human dynamics and environmental conditions.

It will be appreciated that the walker 10 of the present disclosure can be simple to turn on/off and to operate. A toggle switch can be provided on or near a handle area 29 of the frame 12 and can act as the master power switch connecting or disconnecting a battery (not shown). With power on, the walker will stay at rest if no user is detected within the user gap 17 of the frame 12. If the user stands within the user gap 17 but does not wish to move, then the walker 10 will move towards the user to a specified distance and stop. Once the user wishes to walk, he/she will simply move forward and the walker 10 will automatically follow behind. In various embodiments, a tension/compression load cell 31 is secured at the base of the handle area 29 of the frame 12 and functions as a force sensor. The load cell can measure both tension and compression up to a certain limit, such as twenty-five pounds, for example.

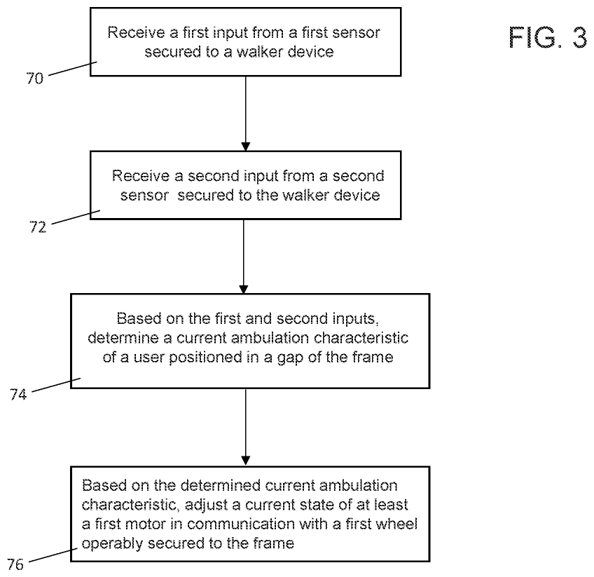

In accordance with various embodiments such as shown in FIG. 3, a method of the present disclosure receives, by the controller, a first input from a first sensor secured to a frame of a walker device as at 70. As at 72, a second input is received from a second sensor secured to the frame of the walker device. As at 74, based on the first and second inputs, a current ambulation characteristic of a user positioned in a user gap defined by the frame is determined. As at 76, a current state of at least the first motor in communication with one of the wheels (e.g., 21 or 22) secured to the frame is adjusted based on the determined current ambulation characteristic.

In various aspects, based on the determined current ambulation characteristic, a current state of the second motor in communication with the other wheel is adjusted based on the determined current ambulation characteristic. As described elsewhere herein, adjusting the current state of the first motor can be performed independently of adjusting the current state of the second motor. It will be appreciated that the determined current ambulation characteristic can be a gait cycle of the user, the first input can be a detected distance from the first sensor to a torso of a user and the second input can be a detected distance from the second sensor to a foot or leg of a user. The current ambulation characteristic of the user can also be a torso direction change and adjusting the current state of the first motor can include directing at least the first wheel to change direction. The second input can also be a detected time period from a heel ground strike of a user to a toe lift-off of the user. The current state of a motor as described herein can be stopped, propelling forward or propelling backward, for example, and adjusting the current state can include applying a braking force when the current state is propelling, or applying a propelling force when the current state is stopped. In embodiments, adjusting the current state of a motor includes directing at least the first wheel to add propulsive force at the toe lift-off of the user and to add braking force at the heel ground strike of the user.

The above-described embodiments of the present disclosure may be implemented in accordance with or in conjunction with one or more of a variety of different types of systems, such as, but not limited to, those described elsewhere herein.

The present disclosure contemplates a variety of different systems each having one or more of a plurality of different features, attributes, or characteristics. A “system” as used herein can refer, for example, to various configurations of: (a) one or more sensor devices; (b) one or more sensor devices, a walker and a central on-board controller; (c) one or more sensor devices and a walker; (d) one or more sensor devices and one or more computing devices communicating via one or more networks; (e) one or more sensor devices, a walker and an onboard central controller; (f) one or more sensor devices, a central controller and one or more motors; (g) one or more sensor devices, a walker, an onboard central controller and one or more motors; (h) a walker and an onboard central controller; and (i) one or more remote computing devices, such as desktop computers, laptop computers, tablet computers, personal digital assistants, mobile phones, and other mobile computing devices. A network as described herein can be wireless or wired, such as a wired communication between the controller, the sensor devices and the motors.

In certain embodiments in which the system includes a computing device such as a central controller onboard a walker or a remote computing device, the computing device is any suitable computing device (such as a server) that includes at least one processor and at least one memory device or data storage device. As further described herein, the computing device includes at least one processor configured to transmit and receive data or signals representing events, messages, commands, or any other suitable information between the computing device and other devices such as a sensor or motor. The processor of the computing device is configured to execute the events, messages, or commands represented by such data or signals in conjunction with the operation of the computing device.

It will be appreciated that any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing, including a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

It will be appreciated that all of the disclosed methods and procedures herein can be implemented using one or more computer programs or components. These components may be provided as a series of computer instructions on any conventional computer-readable medium, including RAM, SATA DOM, or other storage media. The instructions may be configured to be executed by one or more processors which, when executing the series of computer instructions, performs or facilitates the performance of all or part of the disclosed methods and procedures.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a central controller, partly on a central computer, as a stand-alone software package, partly on a central computer and partly on a remote computer or entirely on the remote computer or server. In the latter scenario, the remote computer may be connected to the central controller through any type of network, including a local area network (LAN) or a wide area network (WAN), or the connection may be made to an external computer (for example, through the Internet using an Internet Service Provider).

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables, charts, graphs and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

1. A system, comprising:
a walker device comprising a frame, wherein the frame comprises an upper segment and a lower segment, wherein the frame defines a user gap;
at least one set of wheels rotatably secured to the frame, wherein the at least one set of wheels comprises a first wheel and a second wheel;
a first wheel motor secured to the frame and operable to direct motion and braking of the first wheel;
a second wheel motor secured to the frame and operable to direct motion and braking of the second wheel;
a first sensor secured to the upper segment;
a second sensor secured to the lower segment; and
a controller comprising a processor and a memory storing instructions that, when executed by the processor, cause the processor to:
receive a first input from the first sensor;
receive a second input from the second sensor; and
in response to the first and second inputs, issue a first signal to at least the first wheel motor to direct movement or braking of the first wheel.

2. The system of claim 1, wherein the signal regulates the distance between the frame and a user positioned in the user gap.

3. The system of claim 1, wherein the first input comprises a detected distance from the first sensor to a torso of a user.

4. The system of claim 1, wherein the second input comprises a detected distance from the second sensor to a foot or leg of a user.

5. The system of claim 4, wherein the second input comprises a detected time period from a heel ground strike of a user to a toe lift-off of the user.

6. The system of claim 5, wherein the signal directs at least the first wheel to add propulsive force at the toe lift-off of the user and to add braking force at the heel ground strike of the user.

7. The system of claim 1, wherein the second sensor tracks a gait cycle of a user.

8. The system of claim 1, wherein the first and second sensors are selected from the group consisting of: a laser sensor, an infrared sensor and a depth camera.

9. The system of claim 1, wherein the instructions cause the processor to, in response to the first and second inputs, issue a second signal to the second wheel motor, wherein the second signal is independent of the first signal.

10. The system of claim 1, further comprising an ultrasonic sensor secured to the frame.

11. The system of claim 1, further comprising a force-sensing load cell secured to the frame.

12. A computer-implemented method, comprising:
receiving, by a controller, a first input from a first sensor secured to a frame of a walker device;
receiving, by the controller, a second input from a second sensor secured to the frame of the walker device;
based on the first and second inputs, determining, by the controller, a current ambulation characteristic of a user positioned in a user gap defined by the frame; and
adjusting, by the controller, a current state of at least a first motor in communication with a first wheel operably secured to the frame based on the determined current ambulation characteristic.

13. The method of claim 12, further comprising adjusting, by the controller, a current state of a second motor in communication with a second wheel operably secured to the frame based on the determined current ambulation characteristic.

14. The method of claim 13, wherein adjusting the current state of the first motor is performed independently of adjusting the current state of the second motor.

15. The method of claim 12, wherein the determined current ambulation characteristic comprises a gait cycle of the user.

16. The method of claim 12, wherein the first input comprises a detected distance from the first sensor to a torso of a user.

17. The method of claim 12, wherein the second input comprises a detected distance from the second sensor to a foot of a user.

18. The method of claim 12, wherein the second input comprises a detected time period from a heel ground strike of a user to a toe lift-off of the user.

19. The method of claim 18, wherein adjusting the current state of at least the first motor comprises directing at least the first wheel to add propulsive force at the toe lift-off of the user and to add braking force at the heel ground strike of the user.

20. The method of claim 12, wherein the current ambulation characteristic of the user comprises a torso direction change and wherein adjusting the current state of at least the first motor comprises directing at least the first wheel to change direction.

21. The method of claim 12, wherein the first and second sensors are selected from the group consisting of: a laser sensor, an infrared sensor and a depth camera.
